(19) United States
(12) Patent Application Publication
(10) Pub. No.: US 2013/0196244 A1
(43) Pub. Date: Aug. 1, 2013

(54) FUEL CELL AND FUEL CELL MODULE

(71) Applicant: Sanyo Electric Co., Ltd., Osaka (JP)

(72) Inventors: Hiroki KABUMOTO, Saitama-shi (JP); Takashi YASUO, Ashikaga-shi (JP); Shinichiro IMURA, Ora-gun (JP)

(73) Assignee: SANYO ELECTRIC CO., LTD., Osaka (JP)

(21) Appl. No.: 13/733,707

(22) Filed: Jan. 3, 2013

Related U.S. Application Data
(62) Division of application No. 11/806,305, filed on May 31, 2007, now abandoned.

(30) Foreign Application Priority Data
May 31, 2006 (JP) 2006-152653

(51) Int. Cl. H01M 8/10

(52) U.S. Cl. CPC H01M 8/1004
USPC 429/465; 429/482

(57) ABSTRACT

A base as a support in a fuel cell is provided with a plurality of through holes. An electrolyte membrane covers the entirety of the base facing the anode and is partly embedded in the plurality of through holes. A cathode is embedded in the through holes such that each block is in an isolated area bounded by the base and the electrolyte membrane. A current collector is provided on the blocks of the cathode and on the base partitioning the cathode. The current collector is secured to the base by a securing member.

### CROSS-REFERENCE TO RELATED APPLICATIONS

This application is based upon and claims the benefit of priority from the prior Japanese Patent Application No. 2006-152653, filed May 31, 2006, the entire contents of which are incorporated herein by reference.

### BACKGROUND OF THE INVENTION

1. Field of the Invention

The present invention relates to a fuel cell and, more particularly, to size reduction of a fuel cell.

2. Description of the Related Art

A fuel cell is a device that generates electricity from hydrogen and oxygen and achieves highly efficient power generation. Unlike conventional power generation, a fuel cell allows direct power generation that does not require conversion into thermal energy or kinetic energy. As such, even a small-scale fuel cell achieves highly efficient power generation. Other features unique to a fuel cell include less emission of nitrogen compounds, etc. and environmental benefits due to small noise and vibration. As described, a fuel cell is capable of efficiently utilizing chemical energy in fuel and as such environmentally friendly. Fuel cells are envisaged as an energy supply system for the twenty-first century and have gained attention as a promising power generation system that can be used in a variety of applications including space applications, automobiles, mobile appliances and large and small scale power generation. Serious technical efforts are being made to develop practical fuel cells.

Of various types of fuel cells, a solid polymer fuel cell is unique in its low operating temperature and high output density. Recently, direct methanol fuel cells (DMFC) are especially highlighted. In a DMFC, methanol water solution as a fuel is not reformed and is directly supplied to an anode so that electricity is produced by an electrochemical reaction induced between the methanol water solution and oxygen. Reaction products resulting from an electrochemical reaction are carbon dioxide being emitted from an anode and generated water emitted from a cathode. Methanol water solution is richer in energy per unit area than hydrogen. Moreover, it is suitable for storage and poses little danger of explosion. Accordingly, it is expected that methanol water solution will be used in power supplies for automobiles, mobile appliances (cell phones, notebook personal computers, PDAs, MP3 players, digital cameras, electronic dictionaries (books)) and the like.

In the related-art fuel cells, band clamping or screw clamping is required in order to improve sealing reliability with respect to fuel cell and air, to reduce contact resistance between a current collector and an electrode, or to improve the capability of collecting current from an MEA. This has made it difficult to reduce the size of a fuel cell.

Further, in a structure where a current collector is secured at the periphery of an electrode of conventional dimensions (on the order of centimeters), it is difficult to secure uniform contact between a current collector and an electrode. More specifically, the intimacy of contact between a current collector and an electrode is impaired at the center of the electrode.

Yet another problem with a related-art fuel cell is that cross leak of liquid fuel from an anode to a cathode is liable to occur as a result of swelling of an electrolyte membrane due to moisture absorption, thereby reducing the efficiency of using liquid fuel.

Further, in the related-art fuel cell, structure is employed where the electrolyte membrane is made larger than the electrode, and a gasket is placed on the electrolyte membrane at the periphery of the electrode. This has resulted in a portion of liquid fuel being in direct contact with the electrolyte membrane in a gap between the gasket and the electrode, lowering the efficiency of using liquid fuel.

Another problem is that the fuel cell, for use as a power supply for mobile equipment, is damaged due to vibration occurring while the fuel cell is being carried, external pressure or dropping, with the result that the fuel cell is incapable of generating power.

### SUMMARY OF THE INVENTION

In this background, a general purpose of the present invention is to provide a high-power and small-sized fuel cell.

One embodiment of the present invention relates to a fuel cell. The fuel cell according to this embodiment comprises: an insulating base provided with a plurality of minute through holes which open to both major surfaces; an electrolyte membrane embedded in the plurality of through holes; an anode bonded to one of the surfaces of the electrolyte membrane; and a cathode bonded to the other surface of the electrolyte membrane, wherein the anode or the cathode comprises: a current collector which includes a plurality of electrode elements embedded in one of the major surfaces of the base as blocks isolated in the through holes, and which electrically connects the plurality of electrode elements to each other; and a securing member which secures the current collector to the base, which partitions the electrode elements.

According to this embodiment, a highly efficient and small-sized fuel cell is obtained.

The current collector may be a mesh conductor, and the securing member may be bonded to the base via an interstice in the current collector.

Another embodiment of the present invention also relates to a fuel cell. The fuel cell according to this embodiment comprises: an insulating base provided with a plurality of minute through holes which open to both major surfaces; an electrolyte membrane embedded in the plurality of through holes; an anode which is bonded to one of the surfaces of the electrolyte membrane and which comprises a plurality of anode electrode elements embedded in one of the major surfaces of the base as blocks isolated in the plurality of through holes; an anode current collector which electrically connects the plurality of anode electrode elements to each other; an anode securing member which secures the anode current collector to the base around the anode electrode elements; a cathode which is bonded to the other surface of the electrolyte membrane and which comprises a plurality of cathode electrode elements embedded in the other major surface of the base as blocks isolated in the plurality of through holes; a cathode current collector which electrically connects the plurality of cathode current collectors to each other; and a cathode securing member which secures the cathode current collector to the base around the cathode electrode elements.

According to this embodiment, the size of a fuel cell is further reduced without impairing the current collecting capability of an electrode.

The anode current collector and the cathode current collector may be mesh conductors, the anode securing member may be bonded to the base via an interstice in the anode current collector, and the cathode securing member may be bonded to the base via an interstice in the cathode current collector.

Another embodiment of the present relates to a fuel cell module. In this fuel cell module, a plurality of fuel cells according to any of the aforementioned embodiments are horizontally arranged, and the fuel cells are electrically connected in series. A reinforcing member may be provided between adjacent fuel cells in the fuel cell module.

It is to be noted that any arbitrary combination or rearrangement of the above-described structural components and so forth are all effective as and encompassed by the present embodiments. Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A is a top view showing the structure of a fuel cell according to a first embodiment;

FIG. 1B is a sectional view along a line A-A′ of FIG. 1A;

FIG. 2A is a top view showing the structure of a base used in the first embodiment;

FIG. 2B is a sectional view along a line A-A′ of FIG. 2A;

FIGS. 3A-3F show a method of fabricating the fuel cell according to the first embodiment;

FIG. 4 is an enlarged view showing a securing member of FIG. 3F;

FIG. 5 is a sectional view showing the structure of a fuel cell according to a second embodiment;

FIG. 6 is a sectional view showing the structure of a fuel cell according to a third embodiment;

FIGS. 7A-7D are sectional views showing a method of fabricating the fuel cell according to the third embodiment;

FIG. 8A is a top view showing the structure of a fuel cell module according to a fourth embodiment;

FIG. 8B is a sectional view along a line A-A′ of FIG. 8A;

FIGS. 9A-9E are sectional views showing a method of fabricating the fuel cell module according to the fourth embodiment;

FIG. 10 is a sectional view showing the structure of a fuel cell according to a fifth embodiment; and

FIGS. 11A-11D are sectional views showing a method of fabricating the fuel cell according to the fifth embodiment.

### DETAILED DESCRIPTION OF THE INVENTION

The invention will now be described by reference to the preferred embodiments. This does not intend to limit the scope of the present invention, but to exemplify the invention.

### First Embodiment

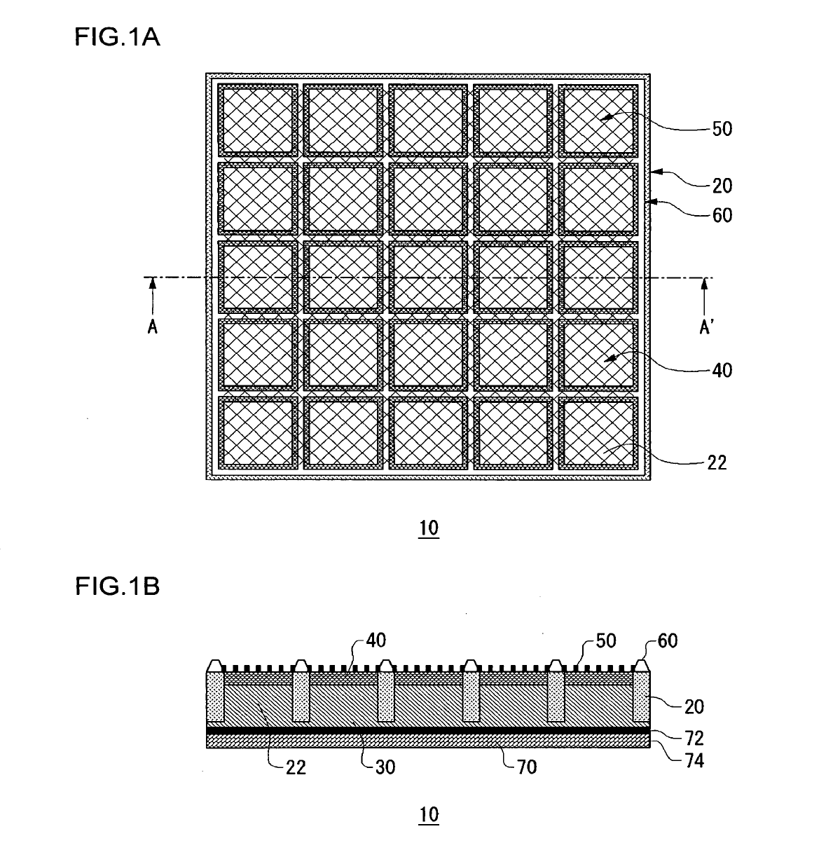

FIG. 1A is a top view showing the structure of a fuel cell 10 according to a first embodiment. FIG. 1B is a sectional view along a line A-A′ of FIG. 1A. The fuel cell 10 comprises a base 20, an electrolyte membrane 30, a cathode 40, a current collector 50, a securing member 60 and an anode 70. The fuel cell 10 according to this embodiment generates electric power by inducing an electrochemical reaction between a methanol water solution as a liquid fuel and air.

The base 20 comprises a plurality of through holes 22 which open to both major surfaces. The opening formed by the through holes 22 according to this embodiment is rectangular in shape. The plurality of through holes 22 are arranged in a matrix. The length of one side of the through hole 22 is, for example, 0.5-2.0 mm. The base 20 is formed of, for example, porous silicon, polyimide etc. The opening formed by the through hole 22 may not be rectangular in shape and may have the shape of a polygon other than a rectangle, or the shape of a circle. To control variation in power generating performance on the surface, the plurality of through holes 22 are preferably arranged at regular intervals. The thickness of the base 20 is, for example, 10-30 μm.

The electrolyte membrane 30 covers the entirety of the base 20 facing the anode and is partly embedded in the plurality of through holes 22. The electrolyte membrane 30 may be formed of, for example, Nafion (trademark).

The cathode 40 is embedded in the through holes 22 such that each block is in an isolated area bounded by the base 20 and the electrolyte membrane 30. The cathode 40 is formed of, for example, a mixture of platinum black and Nafion.

The current collector 50 is provided on the blocks of the cathode 40 and on the base 20 partitioning the cathode 40. The current collector 50 is in contact with the blocks of the cathode 40 partitioned by the base 20. In this way, the blocks of the cathode 40 partitioned by the base 20 are electrically connected to each other. The current collector 50 is formed of, for example, gold mesh.

The securing member 60 is formed on the base 20 via the current collector 50. The securing member 60 is fused with the base 20 via an interstice in the current collector 50. Since the securing member 60 properly secures the current collector 50 to the base 20, the intimacy of contact between the securing member 60 and the cathode 40 is improved. The securing member 60 is formed of, for example, glass. For prevention of corrosion, it is preferable to cover the surface of the securing member 60 with a protective layer of platinum, gold etc.

The anode 70 comprises an anode catalyst layer 72 and a porous anode base 74. The anode catalyst layer 72 fills one of the surface layers of the anode base 74. The anode catalyst layer 72 is bonded with the surface of the electrolyte membrane 30 facing the anode.

The anode catalyst layer 72 is formed of, for example, a mixture comprising platinum ruthenium black and Nafion. The anode base 74 is formed of, for example, carbon paper, carbon cloth etc.

In the fuel cell 10 according to this embodiment, each block of the cathode 40 provided in each through hole 22, the electrolyte membrane 30 and the anode 70 opposite to the cathode 40 across the electrolyte member 30 function as a small electrochemical device. The anode 70 serves as an electrode common to the electrochemical devices. On the other hand, the cathode 40 is partitioned into isolated blocks each constituting an electrochemical device. The fuel cell 10 is formed as a set of electrochemical devices supported by the base 20, by electrically connecting the blocks of the cathode 40 to each other by the current collector 50. Since each block of the cathode 40 is of a fine structure, uniform contact between the cathode 40 and the current collector 50 within the surface is achieved, thereby reducing contact resistance between the cathode 40 and the current collector 50.

According to the fuel cell 10 of this embodiment, the current collecting capabilities of the fuel cell is improved at least without using a clamping mechanism such as a band for clamping the cathode. This will eventually lead to size reduction of the fuel cell.

Since the electrolyte membrane is supported by the base, swelling of the electrolyte membrane is suppressed so that the likelihood of cross leak of liquid fuel is reduced.

By omitting a mechanism for clamping the cathode, the fuel cell becomes pliable so that damage to the fuel cell as a result of carrying the fuel cell is minimized. Since liquid fuel does not come into direct contact with the electrolyte membrane, the efficiency of using liquid fuel is improved.

In this embodiment, the cathode is partitioned into isolated electrochemical devices, and the anode serves as an electrode common to the electrochemical devices. Alternatively, the structures of the cathode and the anode may be interchanged.

(Fabrication Method)

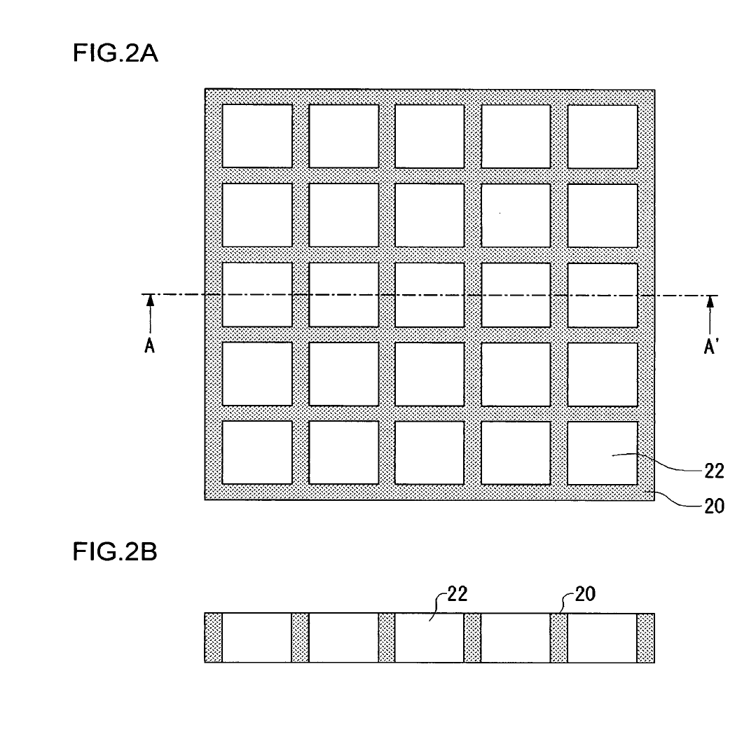

As shown in FIGS. 2A and 2B, a porous silicon substrate having regularly arranged through holes 22 is prepared as a base 20. Formation of a silicon substrate having regularly arranged through holes 22 is achieved by, for example, a combination of known photolithography and etching processes.

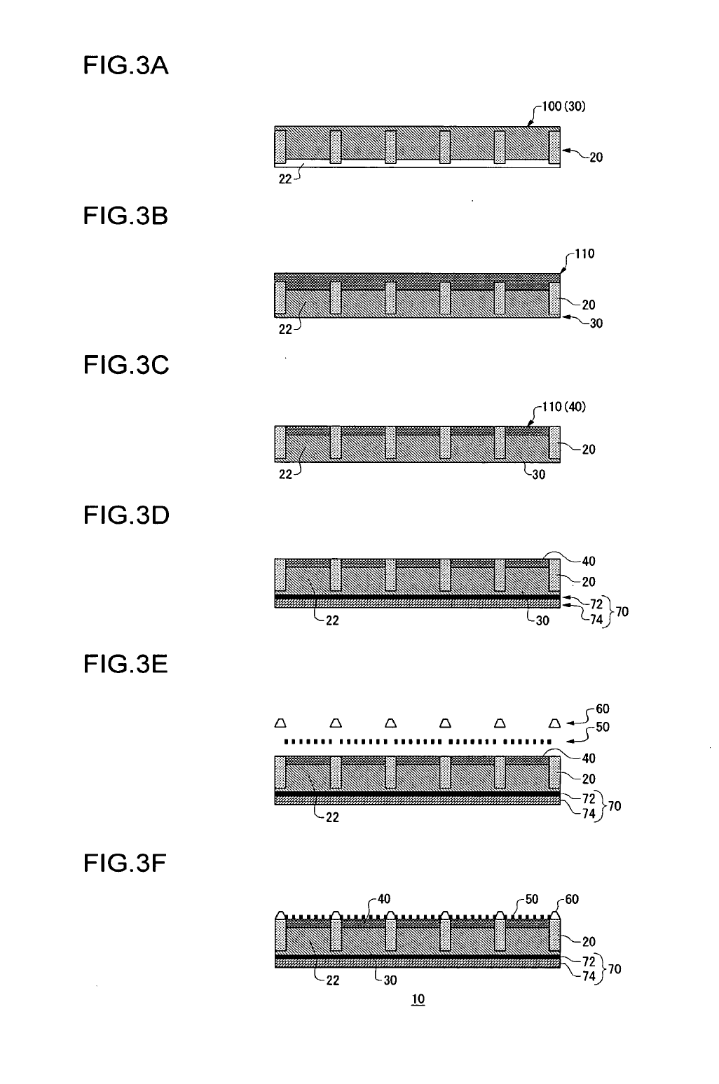

As shown in FIG. 3A, a commercially available Nafion solution 100 is introduced via one surface of the base 20, by using a bar coater or by screen printing. With this, the entirety of the Nafion-coating surface of the base 20 is coated with the Nafion solution 100. Opposite to the Nafion-coating surface, the through holes 22 provided in the base 20 are blocked up by the Nafion solution, forming a plurality of recesses. Subsequently, the Nafion solution 100 is sucked from the side opposite to the Nafion-coating surface while maintaining the assembly at 90° C., so as to remove the solvent in the Nafion solution. In this way, the electrolyte membrane 30 supported by the base 20 is formed.

Then, as shown in FIG. 3B, the surface opposite to the Nafion-coating surface is coated by screen printing with catalyst ink 110 composed of platinum black, Nafion and Teflon (trademark) dispersion. This results in the recesses bounded by the electrolyte membrane 30 at the bottom and by the base 20 at the sides are filled with the catalyst ink 110. The entirety of the surface of the base 20 opposite to the Nafion-coating surface is covered by the catalyst ink 110.

Then, as shown in FIG. 3C, the catalyst ink 110 is removed by a squeezee so that the base 20 is exposed on the surface opposite to the Nafion-coating surface. The assembly is then heated at 80° C. and dried. Through these steps, the blocks of the cathode 40 are formed inside the through holes 22 provided in the base 20.

Then, as shown in FIG. 3D, the anode base 74 formed of carbon cloth is thermocompression bonded to the Nafion-coating surface, the anode base 74 comprising on its surface layer the anode catalyst layer 72 formed of platinum ruthenium black and Nafion, so that the anode catalyst layer 72 of the anode 70 is bonded to the electrolyte membrane 30.

Then, as shown in FIG. 3E, the current collector 50 formed of, for example, gold mesh, is placed on the blocks of the cathode 40 and on the base 20. The securing member 60 formed of glass is then placed on top of the current collector 50. The securing member 60 is provided with the same arrangement of holes as the base 20. Alternatively, the holes in the securing member 60 may be larger in diameter than those of the base 20. The securing member 60 is preferably formed of a low-melting material with a melting point of about 200° C.

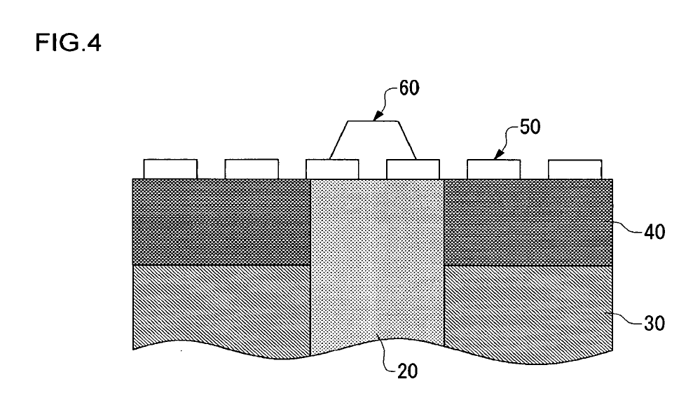

Then, as shown in FIGS. 3F and 4, the securing member 60 is softened by heating it at about 200° C. so as to bring the base 20 and the securing member 60 into contact with each other. In this state, a high voltage (50V or greater) is applied to the surface of contact between the base 20 and the securing member 60, with the base 20 being used as an anode so that the securing member 60 is fused with the base 20 via an interstice in the current collector 50.

According to the fabrication method described above, a fuel cell with a reduced size is fabricated.

### Second Embodiment

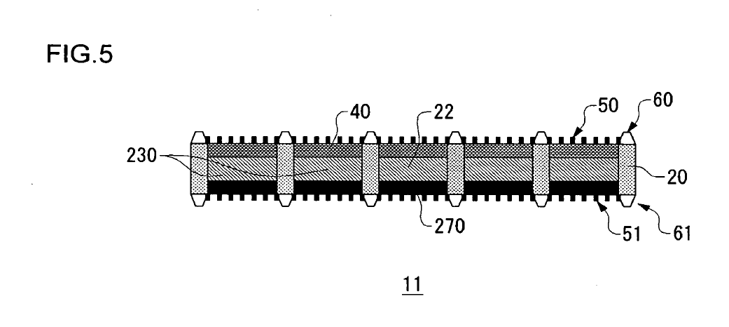

FIG. 5 is a sectional view showing the structure of a fuel cell 11 according to a second embodiment. The fuel cell 11 of this embodiment has a similar structure to that of the fuel cell 10 according to the first embodiment except that an electrolyte membrane 230 is formed as blocks isolated in the through holes 22 and that an anode 270 and its current collection structure have a structure similar to that of the cathode 40 of the first embodiment. In describing the fuel cell 11 below, components that are similar to those of the first embodiment are denoted by the same reference numerals and the description thereof is omitted. The description below highlights differences from the first embodiment.

The electrolyte membrane 230 is partitioned by the base 20 and formed as blocks isolated in the through holes 22. The electrolyte membrane 230 is formed by removing surplus Nafion solution such that the Nafion solution applied in the step of FIG. 3A of the first embodiment is partitioned by the base 20.

The anode 270 is embedded in the through holes 22 such that each block is in an isolated area bounded by the base 20 and the electrolyte membrane 30. The anode 270 is formed of, for example, a mixture of platinum black and Nafion. The anode 270 is formed through steps similar to those of FIGS. 3B and 3C of the first embodiment.

A current collector 51 is provided on the blocks of the anode 270 and on the base 20 partitioning the anode 270. The current collector 51 is in contact with the blocks of the anode 270 partitioned by the base 20. In this way, the blocks of the anode 270 partitioned by the base 20 are electrically connected to each other. The current collector 51 is formed of, for example, gold mesh.

A securing member 61 is formed on the base 20 via the current collector 51. The securing member 61 is fused with the base 20 via an interstice in the current collector 51. Since the securing member 61 properly secures the current collector 51 to the base 20, the intimacy of contact between the securing member 61 and the anode 270 is improved. The securing member 61 is formed of, for example, glass. For prevention of corrosion, it is preferable to cover the surface of the securing member 61 with a protective layer of platinum or gold.

The current collection structure of the anode 270 is formed through steps similar to those of FIGS. 3E and 3F of the first embodiment.

In the fuel cell 11 according to this embodiment, the cathode 40, the electrolyte membrane 30 and the anode 270 opposite to the cathode 40 across the electrolyte member 30 are respectively formed in the through holes 22 so that each unit functions as an electrochemical device. The cathode 40, the electrolyte membrane 30 and the anode 270 are partitioned into separate blocks each constituting an electrochemical device. The fuel cell 11 is formed as a set of electrochemical devices supported by the base 20, by electrically connecting the blocks of the cathode 40 to each other and connecting the blocks of the anode 270 to each other by the current collector 50 and the current collector 51, respectively. Since each block of the cathode 40 and the anode 270 is of a fine structure, uniform contact between the cathode 40 and the current collector 50 and between the anode 270 and the current collector 51 within the surface is achieved, thereby reducing contact resistance. Accordingly, the current collecting capability of the fuel cell is improved without requiring a clamping mechanism such as a band for clamping the cathode or the anode, thereby allowing further size reduction.

### Third Embodiment

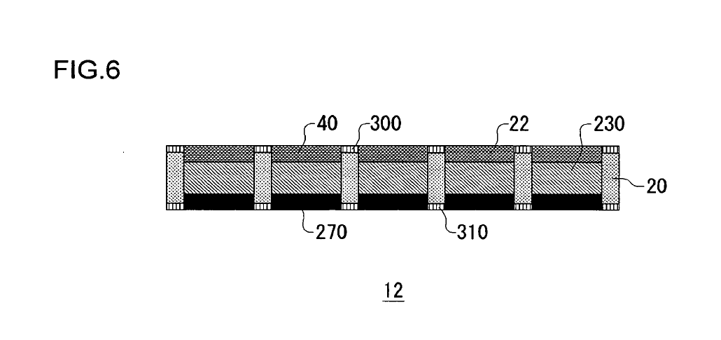

FIG. 6 is a sectional view showing the structure of a fuel cell 12 according to a third embodiment. The fuel cell 12 is similar to that of the second embodiment in that electrochemical devices are independently formed in the through holes 22 provided in the base 20, each device being formed by the cathode 40, the electrolyte membrane 30 and the anode 270. In describing the fuel cell 12 below, components that are similar to those of the second embodiment are denoted by the same reference numerals and the description thereof is omitted. The description below highlights differences from the second embodiment.

In the fuel cell 12 according to the third embodiment, a current collector layer 300 is provided on the porous base 20 partitioning the cathode 40 into blocks and formed of, for example, a polyimide film. The current collector layer 300 is formed of a conductor such as platinum, gold or palladium. The thickness of the current collector layer 300 is, for example, 0.5-3.0 μm. The current collector layer 300 electrically connects the blocks of cathode 40 to each other.

Similarly, a current collector layer 310 is provided on the base 20 partitioning the anode 270 into blocks. The current collector layer 310 is formed of, for example, a conductor such as platinum, gold and palladium. The thickness of the current collector layer 310 is, for example, 0.5-3.0 μm. The current collector layer 310 electrically connects the blocks of the anode 270 to each other.

According to the structure of this embodiment, the cathode blocks each bounded by the base are electrically connected to each other, and the anode blocks each bounded by the base are electrically connected to each other, without using a current collector of, for example, gold mesh. By simplifying the current collection structure of the anode and cathode, the current collection performance of the anode and the cathode is improved. By reducing the number of components used, the fabrication cost is further reduced.

(Fabrication Method)

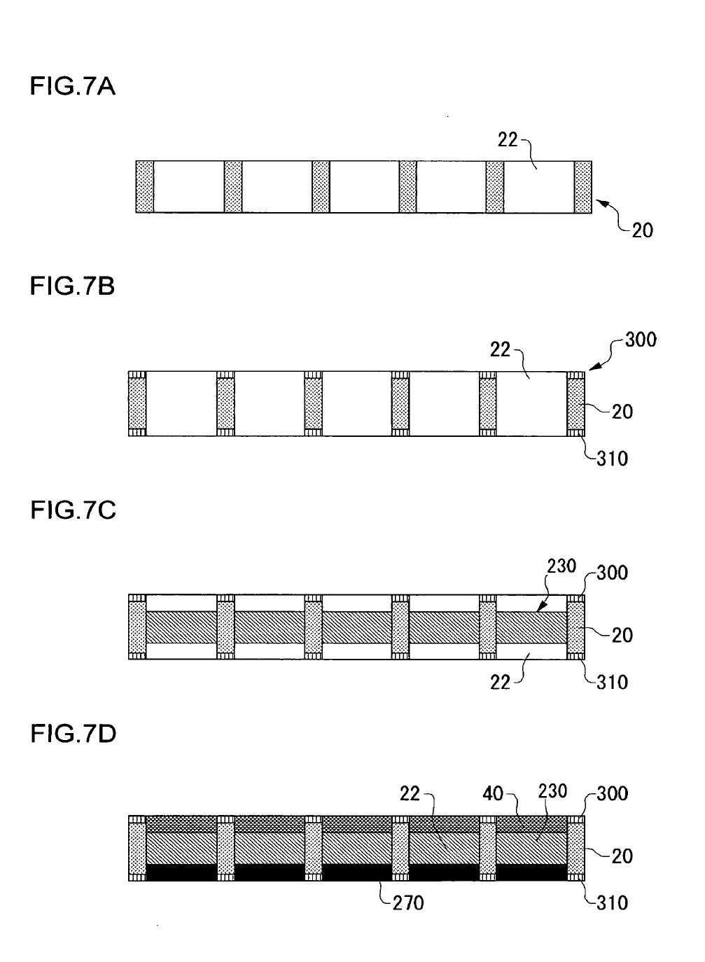

As shown in FIG. 7A, a porous polyimide film having regularly arranged through holes 22 is prepared as a base 20. Formation of a polyimide film having regularly arranged through holes 22 is achieved by, for example, a combination of known photolithography and etching processes.

Then, as shown in FIG. 7B, the current collector layer 300 and the current collector layer 310, each being a conductor formed of platinum, gold or palladium, are formed on the respective major surfaces of the base 20 by, for example, sputtering.

Then, as shown in FIG. 7C, the electrolyte membrane 230 is formed in the through holes 22, as in the second embodiment.

Then, as shown in FIG. 7D, the cathode 40 is embedded in the through holes 22 such that each block is in an isolated cathode area bounded by the base 20 and the electrolyte membrane 230, as in the second embodiment. The anode 270 is embedded in the through holes 22 such that each block is in an isolated anode area bounded by the base 20 and the electrolyte membrane 230.

### Fourth Embodiment

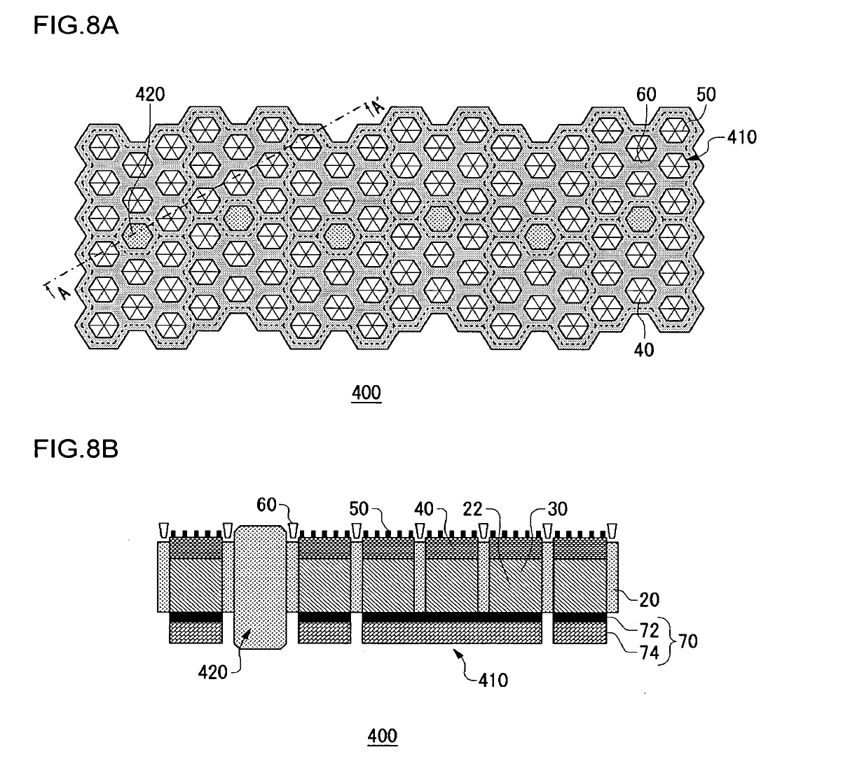

FIGS. 8A and 8B show the structure of a fuel cell module 400 according to a fourth embodiment. The fuel cell module 400 according to this embodiment has a structure in which a plurality of fuel cells (unit cells) 410 (portions surrounded by broken lines in FIG. 8A) are horizontally arranged. The basic structure of each fuel cell 410 is the same as that of the first embodiment. In describing the fuel cell module 400 below, components that are similar to those of the first embodiment are denoted by the same reference numerals and the description thereof is omitted. The description below highlights differences from the first embodiment.

The fuel cell module 400 according to this embodiment comprises a horizontal arrangement of twelve fuel cells 410 each including an arrangement of eight electrochemical devices. In each fuel cell 410, the electrolyte membrane 230 is formed as blocks isolated in the through holes 22. In each fuel cell 410, the anode 70 is bonded to the electrolyte membrane 30 and serves as an electrode common to the eight electrochemical devices. The plurality of fuel cells 410 are electrically connected in series by a wiring (not shown).

In each fuel cell 410, the blocks of the cathode 40 are electrically connected to each other by the current collector 50. As in the first embodiment, the current collector 50 is secured between the securing member 60 and the base 20.

A reinforcing member 420 formed of, for example, silicon, is provided in at least one through hole 22 formed between the adjacent fuel cells 410. By connecting the reinforcing member 420 to the housing (not shown) provided at the anode side and the cathode side, the strength of the fuel cell module 400 is improved and damage is prevented from occurring while carrying the module.

(Fabrication Method)

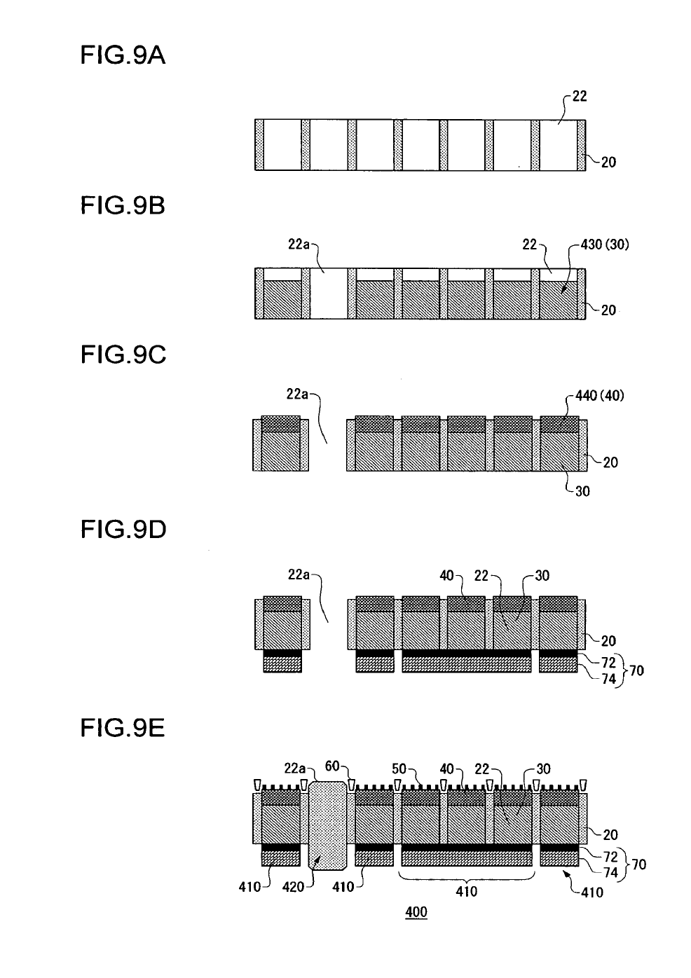

As shown in FIG. 9A, a base 20 having a honeycomb arrangement of hexagonal through holes 22 is prepared (see FIG. 8A for the structure of the base 20 in top view). The base 20 may be obtained by forming holes by irradiating a polyimide film with excimer laser.

Then, as shown in FIG. 9B, a Nafion solution 430 is introduced via one of the surfaces of the base 20, by using a bar coater or by screen printing, while masking (not shown) a through hole 22a in which the reinforcing member is to be formed. This forms a plurality of recesses on one of the major surfaces (cathode side) of the base 20. Subsequently, the Nafion solution 430 is sucked from the side opposite to the Nafion-coating surface, while maintaining the assembly at 90° C., so as to remove the solvent in the Nafion solution. In this way, the electrolyte membrane 30 supported by the base 20 is formed.

Then, as shown in FIG. 9C, the plurality of recesses formed in one of the major surfaces of the base 20 are coated by screen printing with catalyst ink 440 composed of platinum black, Nafion and Teflon dispersion. This results in the recesses bounded by the electrolyte membrane 30 at the bottom and by the base 20 at the sides are filled with the catalyst ink 440. The catalyst ink 440 functions as the cathode 40.

Then, as shown in FIG. 9D, the anode base 74 formed of carbon cloth is thermocompression bonded to the other major surface (anode side) of the base 20, the anode base 74 comprising on its surface layer the anode catalyst layer 72 formed of platinum ruthenium black and Nafion, so that the anode catalyst layer 72 of the anode 70 is bonded to the electrolyte membrane 30.

Then, as shown in FIG. 9E, the current collector 50 formed of, for example, gold mesh, is placed on the cathode 40 of each of the fuel cells 410. The securing member 60 is then placed on top of the current collector 50. By means of anode bonding as described with reference to FIGS. 3F and 4, the securing member 60 is fused with the base 20 via an interstice in the current collector 50. The mask (not shown) provided in the through hole 22a in which the reinforcing member is to be formed is removed so that the through hole 22a is filled with the reinforcing member 420 formed of, for example, silicon.

According to the fabrication method, a fuel cell module unlikely to be damaged while being carried is fabricated.

### Fifth Embodiment

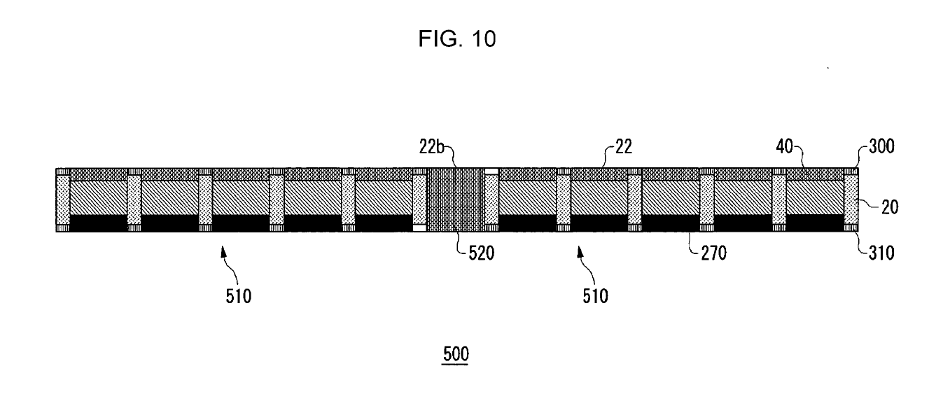

FIG. 10 shows the structure of a fuel cell module 500 according to a fifth embodiment. The fuel cell module 500 according to this embodiment has a structure in which a plurality of fuel cells (unit cells) 510 each having a plurality of electrochemical devices are horizontally arranged. The basic structure of each fuel cell 510 is the same as that of the third embodiment. In describing the fuel cell module 500 below, components that are similar to those of the third embodiment are denoted by the same reference numerals and the description thereof is omitted. The description below highlights differences from the third embodiment.

In the fuel cell module 500 according to this embodiment, a conducting unit 520 is provided in a through hole 22b provided between the adjacent fuel cells 510. The conducting unit 520 electrically connects the anode of one of the fuel cells 510 to the cathode of the other fuel cell 510.

The conducting unit 520 is formed by filling the through hole 22b, provided in the base 20, with a conductive paste containing a metal such as Ni, Au, Ag or Pt, or by filling the hole 22b with a metal such as Ni, Au, Ag or Pt by electroplating.

According to this embodiment, fuel cells each having a set of electrochemical devices are electrically connected in series by means of a simple structure.

(Fabrication Method)

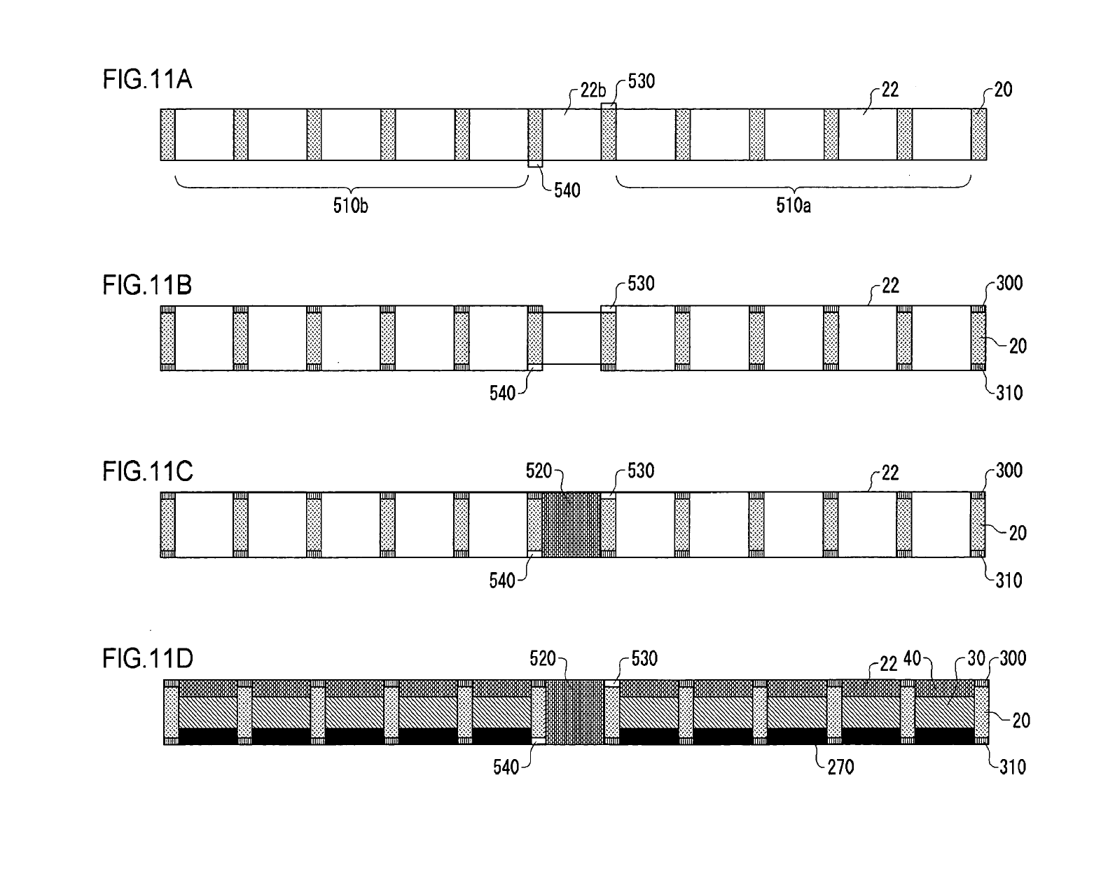

As shown in FIG. 11A, a mask 530 is formed by screen printing on a portion of one of the major surfaces of the base 20 which portion is located to face the opening of the through hole 22b provided in the base 20 for formation of a conducting unit and located at the periphery of a first fuel cell 510a (in the right of FIG. 11A). Similarly, a mask 540 is formed by screen printing on a portion of the other major surface of the base 20 which portion is located to face the opening of the through hole 22b and located at the periphery of a second fuel cell 510b (in the left of FIG. 11A).

Then, as shown in FIG. 11B, the current collector layer 300 and the current collector layer 310, each being a conductor formed of platinum, gold or palladium, are formed on the respective major surfaces of the base 20 by, for example, sputtering.

Then, as shown in FIG. 11C, the conducting unit 520 is formed by filling the through hole 22b, provided in the base 20, with a conductive paste containing a metal such as Ni, Au, Ag or Pt, or by filling the hole 22b with a metal such as Ni, Au, Ag or Pt by electroplating.

Then, as shown in FIG. 11D, the cathode 40, the electrolyte membrane 30 and the anode 270 are formed in the through holes 22 through steps similar to those of the third embodiment.

1-8. (canceled)

9. A fuel cell comprising:
an insulating base provided with a plurality of through holes which open to both major surfaces;
an electrolyte membrane embedded in the plurality of through holes;
an anode bonded to one of the surfaces of the electrolyte membrane; and
a cathode bonded to the other surface of the electrolyte membrane, wherein
the anode or the cathode comprises:
a plurality of electrode elements embedded in one of the major surfaces of the insulating base as blocks isolated in the through holes, wherein a current collector layer that electrically connects the plurality of electrode elements to each other is formed on the insulating base.

10. The fuel cell according to claim 9, wherein the current collector layer is formed of a conductor such as platinum, gold or palladium.

11. A fuel cell module, wherein a plurality of fuel cells according to claim 9 are horizontally arranged, and the fuel cells are electrically connected.

12. A fuel cell module, wherein a plurality of fuel cells according to claim 10 are horizontally arranged, and the fuel cells are electrically connected.

13. The fuel cell module according to claim 11, wherein a conducting unit is provided in the through hole provided between adjacent fuel cells, and the conducting unit electrically connects the anode of one of the fuel cells to the cathode of the other fuel cell.

14. The fuel cell module according to claim 12, wherein the conducting unit is formed by filling the through hole provided in the insulating base with a metal such as Ni, Au, Ag or Pt, or by filling the through hole with a conductive paste containing a metal such as Ni, Au, Ag or Pt.

15. The fuel cell module according to claim 11, wherein a reinforcing member is provided in the through hole provided between adjacent fuel cells.
